(19) United States
(12) Patent Application Publication
(10) Pub. No.: US 2010/0037657 A1
(43) Pub. Date: Feb. 18, 2010

(54) MANUFACTURING METHOD OF GLASS-CERAMICS USING STEEL DUST IN FURNACE

(75) Inventors: Seung gu Kang, Kyeonggi-do (KR); Yoo Taek Kim, Kyeonggi-do (KR); Ki Gang Lee, Kyeonggi-do (KR); Jung Hwan Kim, Kyeonggi-do (KR); Hwan Sik Kim, Seoul (KR)

Correspondence Address: MORGAN & FINNEGAN Transition Team;C/O Locke Lord Bissell & Liddell, 3 WORLD FINANCIAL CENTER, NEW YORK, NY, 10281-2101, US

(73) Assignee: KYONGGI UNIVERSITY INDUSTRY & ACADEMIA COOPERATION FOUNDATION, Suwon, Kyeonggi-do (KR)

(21) Appl. No.: 12/158,742

(22) PCT Filed: Dec. 29, 2006
(86) PCT No.: PCT/KR2006/005871

§ 371 Date: Dec. 10, 2008

(30) Foreign Application Priority Data
Dec. 30, 2005 (KR) 10-2005-0135175

(51) Int. Cl. C03B 27/012

(52) U.S. Cl. 65/33.1

(57) ABSTRACT

The present invention relates to the method of manufacturing crystallized glass composition stable in an acid solution from electric arc furnace dust wasted as an industrial waste in the course of melting and recycling steel scrap in an iron work, the method of manufacturing crystallized glass composition stable in an acid solution using steel dust wasted from an electric furnace, comprising steps of (1) mixing a silicate type glass frit and steel dust wasted from an electric furnace; (2) heating the mixed mixture and melting it to form the melted product; (3) rapidly chilling the melted product in air to form parent glass; (4) thermally treating the parent glass.

### TECHNICAL FIELD

The present invention relates to a method of manufacturing a crystallized glass using steel dust wasted from an electric arc furnace.

More particularly, the present invention relates to a method of manufacturing a crystallized glass from electric arc furnace dust wasted as by-products in the course of melting and recycling iron scrap in the electric arc furnace in iron works.

### BACKGROUND ART

90% or more of the crystallizable glass (Glass-ceramics) is crystallized by thermal treatment accurately controlled in which the crystallized grain has a range of 0.1 μm to 1 μm. A small amount of grains having residue glassy phase is filled effectively into the void of the glass thus making the crystal glass a structure free of the void, the resulting glass product has better mechanical and thermal resistant nature than normal ceramics. The better mechanical resistance of the crystallized glass result from the structure free of the void thus increasing the resistance on the stress. The thermal resistance on thermal impact result from the low thermal expansion coefficients of these material.

Generation of this crystal phase is initiated in the interface of the phases (the core formation is initiated). The core is generated in a few isolated slits along a surface of the container for melting in a normal glass in a melted state, and then a few large crystal developments are followed. Resultant micro-structures are rough, large and ununiform. A crystallizable glass is changed in nature by adding several wt % of the core forming agent in the glass. Finely distributed small particles makes the glass having high core density (by mm 3). The optimal temperature exists for generating the core and the small crystal in a given composition.

The crystallizable glass is manufactured by melting kinds of the crystalline starting materials to make one uniform melted product, i.e., amorphous product and shaping and thermally treating the melted product to generate a polycrystalline glass.

The crystallizable glass as polycrystalline glass is used normally for internal or external tile for construction and bottom tile necessary for wear-resistant nature and high strength.

But, the crystallizable glass has a problem that it is difficult to provide stability on the heavy metal by the glassification as the extracted capacity of the heavy metal is increased under the influence of the network modifiers when the amount of adding the steel dust in the glass is increased.

### DISCLOSURE

### Technical Problem

Accordingly, the present invention is invented to solve the problem of the prior art described above, and therefore the object of the invention is to provide a method of manufacturing a crystallized glass using steel dust wasted from a electric arc furnace capable of producing the crystallized glass and stabilizing the heavy metal more safely by adding a silicate glassy frit into steel dust and by melting and thermal treatment of the glass to suppress the extraction of the heavy metals contained in the steel dust wasted from the electric arc furnace.

Also, the another object of the present invention is to provide a method of manufacturing the crystallized glass using steel dust wasted from an electric arc furnace for preventing the heavy metals designated as inhibited wastes by administrative regulation being extracted.

### Technical Solution

To achieve the object of the present invention, in an embodiment the present invention relates to the method of manufacturing crystallized glass composition stable in an acid solution using steel dust wasted from an electric furnace, comprising steps of (1) mixing a silicate type glass frit and steel dust wasted from an electric furnace; (2) heating the mixed mixture and melting it to form the melted product; (3) rapidly chilling the melted product in air to form parent glass; (4) thermally treating the parent glass.

And in an embodiment it is preferred that the total weight of the steel dust to the glass frit in mixing step is in a range of 50-70 wt %.

And in an embodiment it is preferred that the temperature of the melted product in melting step is in a range of 1300-1400° C.

And in an embodiment it is preferred that the temperature of the parent glass in thermally treating step is in a range of 930-970° C.

### Advantageous Effects

As mentioned above, if the amount of adding steel dust is increased, the extraction of heavy metals is also increased under the influence of the network-modifiers, thus it is difficult to stabilize the heavy metals by glassification. But the present invention stabilize the heavy metals more safely as the extraction of the heavy metals is decreased due to crystallization of the network-modifiers.

### DESCRIPTION OF DRAWINGS

The above and other objects, features and advantages of the present invention will be more apparent from the following detailed description taken in conjunction with the accompanying drawing, in which:

FIG. 1 is a flow chart of manufacturing the crystallized glass according to the present invention.

FIG. 2 is a view of a glass and crystallized glass composition by diffracted by X rays according to the present invention.

FIGS. 3a and 3b are scanning electron microscope photographs on the glass and crystallized glass composition according to the present invention.

### BEST MODE

Now, the method of manufacturing the crystallized glass using the electric arc furnace dust according to the present invention will be hereinafter described with reference to the accompanying drawings.

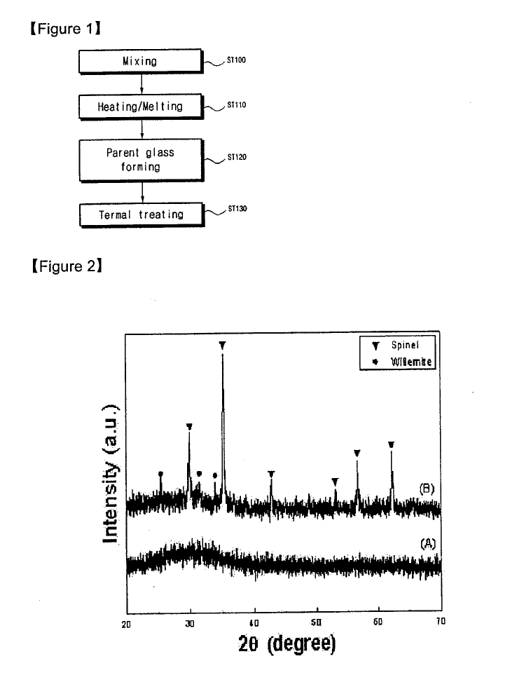

At first, the method of manufacturing crystallized glass using steel dust wasted from an electric arc furnace comprises a step of mixing ST100 a silicate type glass frit and steel dust wasted from an electric arc furnace as is shown in FIG. 1. Here, it is possible whatever normal steel dust originated from a conventional electric arc furnace.

Describing more in detail mixing step ST100, electric arc furnace dust having the composition rate as is in a table 1 is prepared.

TABLE 1
unit: weight %

| | component | | | | | | |
|---|---|---|---|---|---|---|---|
| | CaO | MgO | MnO | ZnO | PbO | P₂O₅ | SO₃ |
| content | 5.0 | 3.2 | 2.4 | 32.8 | 2.6 | 0.3 | 3.4 |
| | component | | | | | | |
| | Na₂O | K₂O | Al₂O₃ | Fe₂O₃ | Cr₂O₃ | SiO₂ | TiO₃ |
| content | 3.5 | 2.5 | 1.5 | 24.6 | 0.3 | 3.6 | 0.1 |

And a silicate glass frit necessary in manufacturing a parent glass having the composition rate as is in a table 2 is prepared.

TABLE 2
unit: weight %

| | component | | | | | | | | |
|---|---|---|---|---|---|---|---|---|---|
| | CaO | MgO | ZnO | BaO | Na₂O | K₂O | Al₂O₃ | B₂O₃ | SiO₂ |
| con- | 10.6 | 0.8 | 7.9 | 2.9 | 2.4 | 4.3 | 6.7 | 6.1 | 58.3 |
| tent | | | | | | | | | |

Both the raw materials mentioned above are screened using a 40 mesh (425 μm) sieve and mixed by a wet ball mill according to a mixing rate as in a table 3 and then mixed mixtures to manufacture a sample of comparative material 1,2 and inventive material 1,2 are produced.

TABLE 3
unit: weight %

| | steel dust | glass frit | thermal treating |
|---|---|---|---|
| inventive 1 | 50 | 50 | treated |
| inventive 2 | 70 | 30 | treated |
| comparative 1 | 50 | 50 | not treated |
| comparative 2 | 70 | 30 | not treated |

And the mixed mixtures are then heated and melted to form the melted product ST110. At this time, the melted temperature of the mixed product is above 1300° C., preferably in a range of 1350-1400° C., to form a glassy property.

And the melted product is rapidly chilled in air to form a parent glass ST120. That is to say, if the mixed product composed like above is melted and then chilled rapidly, the parent glass having a glassy phase will be produced.

Finally, a step of further thermally treating the parent glass formed through the said steps is performed ST1300.

A conventional method comprises two steps, i.e. a first step of generating a core in a glassy material and a second step of developing the crystal core by thermal treating the glassy material to form a crystal phase in the glass material by thermal treating the rapidly chilled parent glass. But the present method according to the present invention comprises steps of thermally treating the parent glass in a range of 930-970° C. and slowly chilling the parent glass in the electric arc furnace to form crystallization.

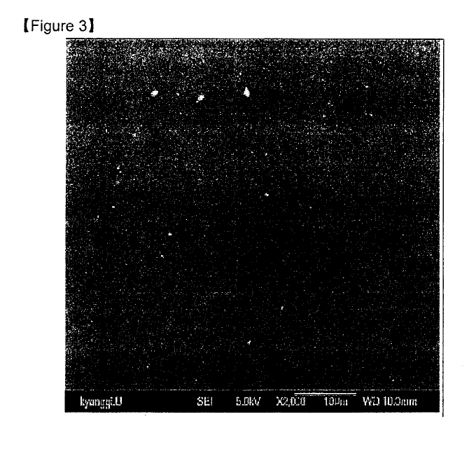

FIG. 2 shows a view of the comparative material 1 and the inventive material 1 diffracted by X rays. Referring to FIG. 2, it will be seen that the parent glass has a typical amorphous diffractive pattern, but the crystallized glass composition has Willemite and Spinel crystal phases.

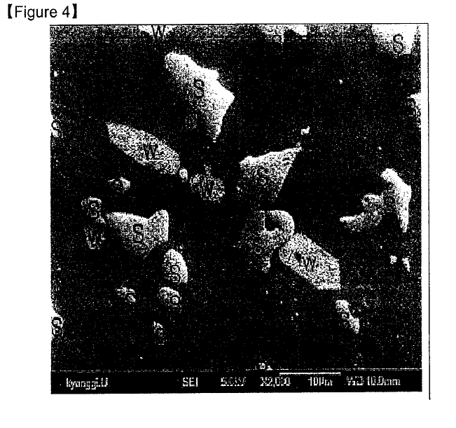

Also, FIG. 3 show SEM (Scanning Electron Microscope) photographs on the comparative material 1 and the inventive material 1. Referring to FIG. 3, it will be seen that the parent glass is in a glass matrix without having a crystal phase, but the crystallized glass composition has two crystal phases, i.e. Willemite crystal phase (denoted by W) and Spinel crystal phase (denoted by S) whose natures are different each other in a glass matrix.

On the one hand, table 4 described below show the result of heavy metal extracting experiment of 2 type materials, i.e. the comparative material and the inventive material.

TABLE 4
unit: weight %

| | component | | | | |
|---|---|---|---|---|---|
| | Cr | Cd | Pb | Fe | Zn |
| inventive 1 | not detected | not detected | 2.7 | 10.4 | 201.1 |
| inventive 2 | not detected | not detected | 2.0 | 6.9 | 483.0 |
| comparative 1 | not detected | not detected | 10.0 | 204.5 | 364.1 |
| comparative 2 | not detected | not detected | 6.3 | 575.3 | 974.9 |

Referring to table 4, it will be seen that the inventive material has less extracted capacity than the comparative material. This shows that the glass which is produced by mixing a silicate glassy frit and 50 wt % or more of electric arc furnace dust has more extracted capacity due to the fracture of the network structure of the glass under the influence of a large amount of network-modifiers, but the crystallized glass composition which is manufactured by thermal treatment has less extracted capacity due to the generation of the crystallized phase.

The present invention is not limited to embodiments described above, rather various modification and changes are obvious to skilled persons in the art which pertains to the spirit and scope of the present invention that is limited by the claims accompanied.

### INDUSTRIAL APPLICABILITY

The present invention relates to a method of manufacturing a crystallized glass from electric arc furnace dust wasted as by-products in the course of melting and recycling iron scrap in the electric arc furnace in iron works.

The present invention is not limited to embodiments described above, rather various modification and changes are obvious to skilled persons in the art which pertains to the spirit and scope of the present invention that is limited by the claims accompanied.

1. Method of manufacturing crystallized glass composition stable in an acid solution using electric arc furnace dust, comprising steps of:
(1) mixing a silicate type glass frit and steel dust wasted from an electric furnace;
(2) heating the mixed mixture and melting it to form the melted product;
(3) rapidly chilling the melted product in air to form parent glass;
(4) thermally treating the parent glass

2. The method according to claim 1, wherein the total weight of the steel dust to the glass frit in mixing step is in a range of 50-70 wt %.

3. The method according to claim 1, wherein the temperature of the melted product in melting step is in a range of 1300-1400° C.

4. The method according to claim 1, wherein the temperature of the parent glass in thermally treating step is in a range of 930-970° C.
